(19) United States
(12) Patent Application Publication
(10) Pub. No.: US 2004/0132520 A1
(43) Pub. Date: Jul. 8, 2004

(54) Method for managing a game for betting on a winning combination

(76) Inventors: Christophe Laurent, Vignoc (FR); Stephanie Lion, Strasbourg (FR); Yan Mei Tang-Talpin, Saint-Gregoire (FR)

Correspondence Address: Joseph S Tripoli, Thomson Licensing Inc, Patent Department, PO Box 5312, Princeton, NJ, 08543-5312, US

(21) Appl. No.: 10/476,934

(22) PCT Filed: Apr. 30, 2002
(86) PCT No.: PCT/FR02/01493

(51) Int. Cl. A63F 13/00

(52) U.S. Cl. 463/16

(57) ABSTRACT

This method for managing a game for betting on at least one winning combination, between a game management center (10) and at least one remote game terminal (16ᵢ) comprises a step (24) which involves choosing, from the game terminal (16ᵢ), a combination of elements from a first set of proposed elements.

The winning combination is a combination of elements from a second set of elements which differs from the first set, and the method furthermore comprises a step (28) involving the generation, by the game management center, of a game ticket (R₁) comprising a table (R₃) of correspondence between each element of the first set and each element of the second set.

### FIELD OF THE INVENTION

The present invention relates to a method for managing a game for betting on at least one winning combination between a game management center and at least one remote game terminal.

More specifically, the invention relates to a method for managing a game of the type which comprises a step of choosing, from the game terminal, a combination of elements from a first set of proposed elements.

### STATE OF THE ART

Generally, in a method of this type, it is necessary for a player to have transmitted the combination of elements chosen from the elements of the first set at the game management center before the latter has broadcast the winning combination of elements drawn at random from the elements of the first set.

In this case, exchanges between the game management center and the remote terminal impose transmission delays which must be taken into account.

Conventional solutions applied to this problem consist in validating in a secure manner the time when the combination chosen by the player is entered on the terminal. However, these solutions become difficult to implement and costly when they are to be applied to an environment in which each player can exchange data with the game management center from a personal terminal such as a microcomputer.

### DESCRIPTION OF THE INVENTION

The invention is intended to eliminate the disadvantages of a conventional game management method.

In a first aspect, the object of the invention is therefore to provide a method for managing a game for betting on at least one winning combination between a game management center and at least one remote game terminal, said method comprising steps which, for the game terminal, consist in: presenting a first set of elements to a player; making up a combination of elements of said first set of proposed elements on the basis of a choice made by said player, and masking said combination; transmitting said masked combination to the game management center; and receiving from said game management center a game ticket containing a table of correspondence between each element of the first set and each element of a second set of elements which differs from the first set; the winning combination being selected from the elements of the second set.

According to a second aspect, the object of the invention is also to provide a method for managing a game for betting on at least one winning combination between a game management center and at least one remote game terminal, said method comprising steps which, for the game management center, consist in: receiving from said game terminal, in masked form, a combination of elements chosen by a player from a first set of elements; generating a game ticket containing a table of correspondence between each element of the first set and each element of a second set of elements which differs from the first set; and transmitting said game ticket to said game terminal; the winning combination being selected from the elements of the second set.

The game management method according to the invention therefore enables the choosing step to be carried out even if the winning combination has already been broadcast. In fact, the choice, possibly made by a player, is derived from a set of elements which differs from the set of elements from which the winning combination is derived. Only the association of the table of correspondence with the combination chosen by the player makes it possible to know if this chosen combination matches the winning combination. It therefore suffices that the player does not know the correspondence table at the time when he makes his choice.

The game management method according to the invention may furthermore comprise one or more of the following characteristics:

it is established whether the chosen combination matches the winning combination by associating this chosen combination with the correspondence table;

the correspondence table is associated in a unique manner with the chosen combination;

the first and second sets comprise the same number of elements;

the game management center and the remote game terminal are interconnected by at least one two-way communications path;

the combination transmitted by the remote game terminal and received by the game management center is encrypted by the remote game terminal before its transmission;

the game ticket generation step comprises the generation of a unique game ticket identifier associated with the correspondence table;

the game ticket transmission step comprises the following steps:

generation of a message comprising the chosen combination and the game ticket,

generation of a signature of at least part of this message, and,

transmission of a receipt, comprising the message and the signature;

the message generated during the game ticket transmission step contains the encrypted chosen combination;

during the game ticket transmission step, the generated message furthermore comprises an identifier of the game management center;

the method furthermore comprises a step of the transmission by the game terminal of a player's proof of winning to the game management center in the event of correspondence between, on the one hand, the winning combination, and, on the other hand, the chosen combination and the correspondence table;

the proof of winning comprises the receipt;

the game terminal generates a symmetrical secret key known to it alone, and:

during the step of the transmission of the chosen combination, the latter is encrypted using the symmetrical secret key, and

the proof of winning comprises the symmetrical secret key;

the game management center comprises a private key known to it alone and associated with a public key known to the game terminal and, during the step of the transmission of the proof of winning, the latter is encrypted using the public key; and

the signature is generated by the game management center using the private key;

the second set comprises a plurality of winning combinations.

### BRIEF DESCRIPTION OF THE DRAWINGS

The invention will be better understood on reading the description which follows, provided purely by way of example and produced with reference to the attached drawings, in which:

FIG. 1 shows an environment in which a game management method according to the invention is implemented; and

FIG. 2 shows the steps of the game management method according to the invention implemented in the environment shown in FIG. 1.

### DETAILED DESCRIPTION OF AN EMBODIMENT OF THE INVENTION

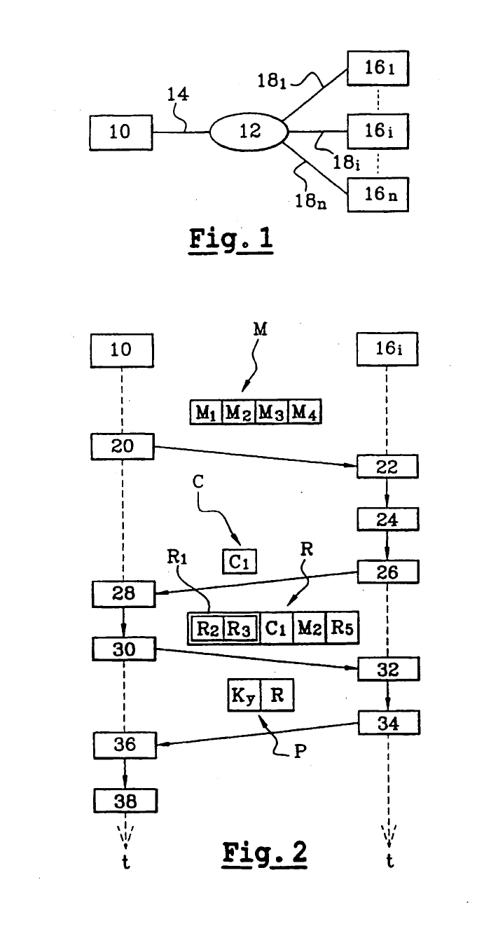

The environment shown in FIG. 1 comprises a game management center 10, located, for example, on the premises of a game organizer and comprising a server in which a game application is run. It is connected to an information transmission network 12, such as the Internet, by means of a two-way link 14.

Moreover, remote game terminals 16₁, . . . , 16ₙ are also connected to the Internet network 12 by means of two-way links 18₁, . . . , 18ₙ. These remote game terminals 16₁, . . . , 16ₙ comprise, for example personal computers, located on the players' premises.

FIG. 2 shows the steps of the game management method according to the invention, implemented between a game management center 10 and any given game terminal 16ᵢ, chosen from the terminals 16₁, . . . , 16ₙ.

During a first step 20, the game management center 10 transmits an authentication message M to the game terminal 16ᵢ.

This message M comprises a game identification number M₁, which differs for each game. In this example, each game comprises a unique winning combination, in such a way that the game identification number M₁ differs for each winning combination.

As an option, the game management center 10 may also send, in the message M, authentication elements which make it possible for the remote game terminal 16ᵢ to verify that this message M originates from a game management center approved by a certification authority, and has not been altered during transmission.

To do this, the message M preferably contains a number M₂ identifying the game management center 10, said number being allocated to it in a unique manner by the certification authority.

The certification authority also allocates to the game management center 10 a certificate M₃ which enables the number M₂ identifying the game management center 10 to be associated with a public key PK_{GP}, according to the following relation:

M₃=Cert(M₂, PK_{GP}),

where Cert is a conventional function.

In fact, a well-known means for securing the transmission of information between the game management center 10 and the remote game terminals 16₁, . . . , 16ₙ involves the use of a public key cryptography method in which the game management center 10 possesses a private key SK_{GP} which is known to it alone and a public key PK_{GP} which is known to the remote terminals. The certification authority itself possesses a private key with which it signs the certificate M₃ and a public key which is known to the remote game terminals, as shown below, to allow them to verify the validity of the certificates.

The certificate M₃ is preferably drawn up according to the ITU-T standard, Recommendation X.509/ISO/IEC 9594-8 which can be referred to for further details.

Finally, the message M comprises a signature M₄, which is a message encrypted, for example, by a chopping function, with the private key SK_{GP}, comprising the game identification number M₁ and the number M₂ identifying the game management center.

During the following step 22, the remote game terminal 16ᵢ verifies the authentication message M.

To do this, it comprises the public key of the certification authority, thanks to which it verifies the content of the certificate M₃ and thus recovers the public key PK_{GP} of the game management center 10.

It also verifies that the number M₂ identifying the game management center 10 matches the number contained in the certificate M₃. Finally, using the public key PK_{GP}, the remote game terminal 16ᵢ verifies that the signature M₄ matches the content of the message M.

Then, during a choosing step 24, the player chooses, from the game terminal 16ᵢ, a combination C₁ of elements of a first set of proposed elements. For example, the set of proposed elements is presented on the screen of the game terminal 16ᵢ in the form of a grid comprising p boxes, of which the player must tick k.

During a step 26, the game terminal 16ᵢ masks the chosen combination, this combination C₁ comprising the k boxes ticked by the player. To do this, in a preferred embodiment, the game terminal 16ᵢ automatically generates in a conventional manner, a symmetrical secret key K_{y} unknown to the game management center 10. It then encrypts the chosen combination C₁ using the symmetrical secret key K_{y}, preferably according to the DES (Data Encryption Standard) in order to obtain a masked combination C₁ (the combination C₁ encrypted using K_{y}).

Finally, the game terminal 16ᵢ transmits the masked combination in the form of a message C.

During the following step 28, on receipt of this message C containing the encrypted chosen combination, the game management center 10 creates a game ticket R₁, comprising, on the one hand, a unique ticket identifier R₂ and, on the other hand, a correspondence table R₃.

The table R₃ establishes the correspondence between the elements of the first set, i.e. the p boxes, and the elements of a second set, such as, for example, the set of p first non-zero natural integral numbers. This table is randomly generated by allocating one of the p integral numbers of the second set to each of the p boxes, each box being associated with a different integral number.

The random generation of the correspondence table R₃ follows the reception of the message C. Thus, the game management center 10 generates a number of correspondence tables R₃ equal to the number of messages C which it receives from the different remote game terminals 16₁, . . . , 16ₙ. The correspondence table R₃ is therefore associated in a unique manner with the chosen combination C₁.

Furthermore, a unique winning combination for the game is selected from all the possible combinations of k numbers from the p integral numbers of the second set. The step of selection of the winning combination, which may be carried out at any given time during the method, is not shown in FIG. 2. This step is, for example, carried out by the game management center 10.

During the following step 30, the game management center 10 transmits a receipt R to the remote game terminal 16ᵢ.

This receipt R comprises the ticket R₁, the chosen masked combination C₁ (in this example, this involves the combination C₁ encrypted by the key K_{y}), the number M₂ identifying the game, and also a signature R₅ comprising the ticket R₁, encrypted by means of the private key SK_{GP}.

During a step 32, the game terminal 16ᵢ receives the message R. It then checks, using the asymmetrical public key PK_{GP}, that the signature R₅ corresponds to the information R₁, C₁, M₂ contained in the message R.

It then presents to the player, on his screen, the correspondence table R₃ contained in the game ticket R₁. This correspondence table R₃ is, for example, presented in the form of a grid comprising p boxes, similar to the grid presented to the player in step 24, but of which each box comprises the number allocated to it in step 28.

Thus, from the combination C₁ and from this new grid which is presented to him, the player can deduce the combination of elements which he has chosen from the elements of the second set of elements. Then, knowing the winning combination, he knows whether he has won the game or not.

If he has won, during a step 34, he transmits to the game management center 10 proof of winning P comprising an element to unmask the masked combination transmitted in the receipt R (in this example, this involves the symmetrical secret key K_{y}) and the receipt R. This proof of winning is transmitted to the game management center 10 in encrypted form, using the asymmetrical public key PK_{GP} of the game management center 10.

During the following step 36, the game management center 10 decrypts the encrypted combination C₁ contained in the receipt R, using the symmetrical K_{y} which has just been transmitted to it.

Finally, during a final step 38, the game management center 10 transmits, for example, a prize-winning certificate to the game terminal 16ᵢ to enable the player to receive his prize on presentation of this certificate.

Any appropriate means can be implemented in order to deliver the prize to the winner.

It will be evident that the game management method according to the invention enables simple implementation of a game for betting on a winning combination, freed from the constraint of synchronizing the step of choosing a combination carried out by the player with the broadcasting of the winning combination.

A further advantage of the method described above is that it enables the player to be sure that the game management center 10 cannot influence the selection of the winning combination on the basis of the chosen combination C₁, by masking the latter (by encrypting it using the symmetrical secret key K_{y}) before transmitting it to the game management center during the transmission step 26.

A further advantage of the method described above is that it enables the player to be sure that he is the only person able to receive his prize in the event of winning, since the symmetrical secret key K_{y} is not known to anyone other than him and the game management center 10.

Finally, it will be noted that the invention is not limited to the embodiment described above.

In fact, as an alternative, the winning combination is selected by a selection center, separate from the game management center 10.

Similarly, as an alternative, the betting game comprises a plurality of winning combinations.

Similarly, as an alternative, the game management center 10 generates a unique correspondence table for each game.

Similarly, as an alternative, the number of elements of the first set is greater than the number of elements of the second set, so that the correspondence table sometimes associates a plurality of elements of the first set with an element of the second set, thereby increasing the chances of winning for the player.

Similarly, as an alternative, the game management center 10 is a server broadcasting audiovisual programs and the remote game terminals 16₁, . . . , 16ₙ are television receivers, decoders or games consoles equipped with means for running the game application. In this case, the game management center and the terminals are connected by a conventional one-way broadcast network such as the Public Switched Telephone Network or high-speed dedicated digital lines.

Finally as an alternative, during the choosing step 24, the latter may be carried out automatically rather than by the player.

Even though, according to the embodiment, the identifier transmitted with the ticket is that of the management center, it is equally possible to implement a game identifier, for example in the case where a plurality of games are managed by the same management center.

1. A method for managing a game for betting on at least one winning combination between a game management center (10) and at least one remote game terminal (16₁, . . . , 16ₙ), characterized in that, for the game terminal (16₁, . . . , 16ₙ), it comprises the following steps:
presenting a first set of elements to a player;
making up a combination (C₁) of elements of said first set of proposed elements on the basis of a choice (24) made by said player, and in masking said combination;
transmitting (26) said masked combination (C₁) to the game management center (10); and
receiving from said game management center a game ticket (R₁) containing a table (R₃) of correspondence between each element of the first set and each element of a second set of elements which differs from the first set;
the winning combination being selected from the elements of the second set.

2. A method for managing a game for betting on at least one winning combination between a game management center (10) and at least one remote game terminal (16₁, . . . , 16ₙ), characterized in that, for the game management center (10), it comprises the following steps:
receiving from said game terminal, in masked form, a combination of elements (C₁) chosen by a player from a first set of elements;
generating (28) a game ticket (R₁) containing a table (R₃) of correspondence between each element of the first set and each element of a second set of elements which differs from the first set; and
transmitting (30) said game ticket (R₁) to said game terminal (16₁, . . . , 16ₙ);
the winning combination being selected from the elements of the second set.

3. The method for managing a game according to one of claims 1 or 2, characterized in that it is established whether the chosen combination (C₁) matches the winning combination by associating this chosen combination (C₁) with the correspondence table (R₃).

4. The method for managing a game according to one of claims 1 to 3, characterized in that the correspondence table (R₃) is associated in a unique manner with the chosen combination (C₁).

5. The method for managing a game according to any one of claims 1 to 4, characterized in that the first and second sets comprise the same number of elements.

6. The method for managing a game according to any one of claims 1 to 5, characterized in that the combination transmitted by the remote game terminal (16₁, . . . , 16ₙ) and received by the game management center (10) is encrypted by the remote game terminal (16₁, . . . , 16ₙ) before its transmission.

7. The method for managing a game according to claim 2, characterized in that the step (28) of generation of the game ticket (R₁) comprises the generation of a unique identifier (R₂) of the game ticket (R₁) associated with the correspondence table (R₃).

8. The method for managing a game according to one of claims 2 or 7, characterized in that the step (30) of transmission of the game ticket (R₁) comprises the following steps:
generation of a message comprising the chosen combination (C₁) and the game ticket (R₁);
generation of a signature (R₅) of at least part of this message; and
transmission of a receipt (R), comprising the message and the signature (R₅).

9. The method for managing a game according to claim 8, characterized in that the message contains the encrypted chosen combination (C₁).

10. The method for managing a game according to one of claims 8 or 9, characterized in that, during the step (30) of transmission of the game ticket (R₁), the generated message furthermore comprises an identifier (M₂) of the game management center (10).

11. The method for managing a game according to claim 1 or any one of claims 3 to 6, taken in their dependence on claim 1, characterized in that it furthermore comprises a step (34) which, for the game terminal (16₁, . . . , 16ₙ), consists in transmitting to the game management center (10) a proof of winning (P) of said player in the event of correspondence between, on the one hand, the winning combination and, on the other hand, the chosen combination (C₁) and the correspondence table (R₃).

12. The method for managing a game according to claim 2 or any one of claims 3 to 10, taken in their dependence on claim 2, characterized in that it furthermore comprises a step which, for the game management center (10), consists in receiving a proof of winning (P) from said player in the event of correspondence between, on the one hand, the winning combination and, on the other hand, the chosen combination (C₁) and the correspondence table (R₃).

13. The method for managing a game according to claims 8 and 11, taken together, characterized in that the proof of winning (P) comprises the receipt (R).

14. The method for managing a game according to claim 11, characterized in that the game terminal (16₁, . . . , 16ₙ) generates a symmetrical secret key (K_{y}) known to it alone, and in that:
during the step (26) of transmission of the chosen combination (C₁), the latter is encrypted using the symmetrical secret key (K_{y}); et
the proof of winning (P) comprises the symmetrical secret key (K_{y}).

15. The method for managing a game according to claim 11, characterized in that the game management center (10) comprises a private key (SK_{GP}) known to it alone and associated with a public key (PK_{GP}) known to the game terminal (16₁, . . . , 16ₙ) and in that, during the step (34) of the transmission of the proof of winning (P), the latter is encrypted using the public key (PK_{GP}).

16. The method for managing a game according to claim 8, characterized in that the game management center (10) comprises a private key (SK_{GP}) known to it alone and associated with a public key (PK_{GP}) known to the game terminal (16₁, . . . , 16ₙ) and in that the signature (R₅) is generated by the game management center (10) using the private key (SK_{GP}).

17. The method according to one of the preceding claims, characterized in that the second set comprises a plurality of winning combinations.
